(19) United States
(12) Patent Application Publication
(10) Pub. No.: US 2015/0381739 A1
(43) Pub. Date: Dec. 31, 2015

(54) NETWORK SESSION CONTROL

(71) Applicant: HANGZHOU H3C TECHNOLOGIES CO., LTD., Hangzhou, Zhejiang (CN)

(72) Inventor: Yongfu CHAI, Beijing (CN)

(21) Appl. No.: 14/768,194

(22) PCT Filed: Feb. 13, 2014
(86) PCT No.: PCT/CN2014/072028

§ 371 Date: Aug. 14, 2015

(30) Foreign Application Priority Data
Feb. 17, 2013 (CN) 201310051572.8

(51) Int. Cl. H04L 29/08; H04L 29/12; H04L 29/06

(52) U.S. Cl. CPC H04L 67/141; H04L 69/22; H04L 61/203; H04L 61/6013; H04L 67/02; H04L 63/083

(57) ABSTRACT

According to an example, a proxy device receives a request packet sent by the session management device, determines a target access device corresponding to the request packet, modifies the destination IP address of the request packet to be the IP address of the target access device while keeping the source IP address of the request packet unchanged, and sends the modified request packet to the target access device.

### BACKGROUND

In conventional networks, users are connected to a NAS (network access server) via access devices, and the NAS is connected with one or multiple session servers. The NAS is configured with access authentication functions. Generally, access devices are network devices having capabilities of switching data, e.g., switches. A session server is a device for managing sessions, and is referred to in the following as a session management device. A session server may include one or multiple servers providing a service, accounting, authentication capabilities and so on. For example, a session server in a portal network may include a web server, a portal server, an AAA (Authentication, Authorization, and Accounting) server, a DHCP (Dynamic Host Configuration Protocol) server and the like. To perform session control, the session server may send a packet to the NAS requesting the NAS to authenticate a user. After receiving the packet, the NAS performs the session control for the user, and returns a response to the session server.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating an access network in accordance with an example of the present disclosure;

FIG. 2 is a flowchart illustrating a network session control method applied to the network as shown in FIG. 1 in accordance with an example of the present disclosure;

FIG. 3 is a schematic diagram illustrating a portal network in accordance with an example of the present disclosure;

FIG. 4 is a flowchart illustrating a network session control method applied to the network as shown in FIG. 3 in accordance with an example of the present disclosure;

FIG. 5 is a schematic diagram illustrating modules of a proxy device in accordance with an example of the present disclosure;

FIG. 6 is a schematic diagram illustrating modules of an access device in accordance with an example of the present disclosure;

FIG. 7 is a schematic diagram illustrating modules of a proxy device in accordance with an example of the present disclosure;

FIG. 8 is a schematic illustrating modules of a switch in accordance with an embodiment of the present invention; and

FIG. 9 is a flowchart illustrating a network session control method in accordance with an example of the present disclosure.

### DETAILED DESCRIPTIONS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, and the term “including” means including but not limited to. The term “based on” means based at least in part on. Quantities of an element, unless specifically mentioned, may be one or a plurality of, or at least one.

In various examples of the present disclosure, multiple devices provide session control functions, and a proxy device distributes request packets. For example, in a network including access devices configured with access functions, which may include devices capable of performing session control, a session management device is capable of exchanging session information with the access devices, and at least one access proxy device (simply referred to as proxy device) is deployed between the access devices and the session management device. The IP address of the proxy device is stored in the access devices and the session management device, and the IP addresses of the access devices are stored in the proxy device. The process of communicating session information between a session management device and an access device may be as follows. A session management device sends a request packet to a proxy device. The proxy device determines a target access device that is corresponding to the request packet, modifies the destination IP address of the request packet to be the IP address of the target access device while keeping the source IP address of the request packet unchanged, and sends the modified request packet to the target access device. The target access device receives the request packet, performs a session control procedure according to the request packet, and acts as the proxy device to return a response packet to the session management device. The procedure of acting as the proxy device to return a response packet to the session management device refers to setting the source IP address of the response packet to be the IP address of the proxy device.

The request packet may include information of a user corresponding to the request packet.

The proxy device may use the user information in the request packet and user information provided by access devices to determine the target access device. In an example, each access device may provide the proxy device at intervals or periodically with information of users connected to the access device. The proxy device may store user information received from the access devices, e.g., in a form of a relation which associates an access device with information of users connected to the access device. Therefore, after receiving the request packet, the proxy device may search stored user information of the access devices for the user whose information is in the request packet, and thus identifies an access device the user is connected to as the target access device.

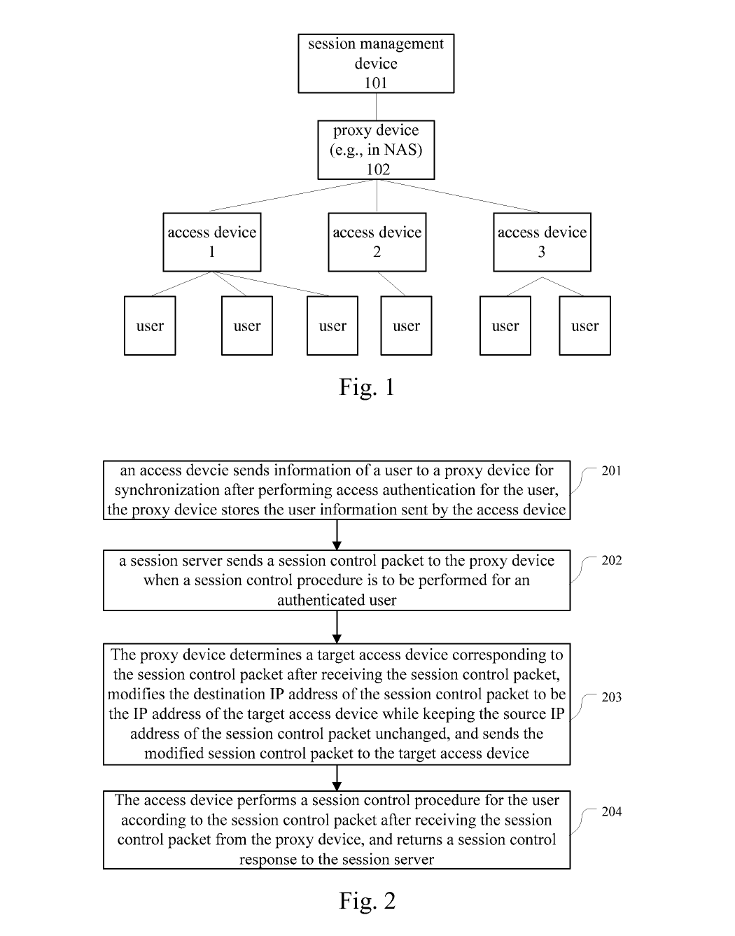

FIG. 1 is a schematic diagram illustrating an access network in accordance with an example of the present disclosure. In an example, access functions are configured in the access devices 1-3 instead of in an NAS. Thus, access authentications of users are performed by the access devices 1-3, not the NAS. A proxy device 102 is deployed between the access devices 1-3 and a session management device 101. In an example, the proxy device 102 may be configured in the NAS.

FIG. 2 is a flowchart illustrating a network session control method applied to the network as shown in FIG. 1 in accordance with an example of the present disclosure. The method is described with respect to the session management device performing session control, e.g., terminating a session, of a connected user as an example. Other types of session control, e.g., establishing a session for a user who has requested to access the network, terminating a session of a user who requested to quit logon, forcing a user to disconnect, or the like, may have similar processing procedures with those as shown in FIG. 2. As shown in FIG. 2, the method may include the following procedures.

At block 201, an access device, e.g., access device 1 shown in FIG. 1, sends information of a user to the proxy device 102 for synchronization after performing access authentication of the user, and the proxy device 102 stores the user information received from the access device 1.

The user information may include information of the user and information of the access device 1 that performed access authentication for the user.

At block 202, the session management device 101 sends a session control packet to the proxy device 102 when a session control procedure is to be performed for an authenticated user.

There may be various session control procedures for users, e.g., establishing a session for a user, terminating a session of a user, forcing a user to disconnect, and so on.

The source IP address of the session control packet may be the IP address of the session management device 101, and the destination IP address of the session control packet may be the IP address of the proxy device 102. The session control packet may also include information of a target user of the session control procedure. The session control packet is a type of request packet sent when the access device and the session server which acts as a terminal exchanges session information.

At block 203, the proxy device 102 receives the session control packet from the session management device 101, determines a target access device corresponding to the session control packet (e.g., access device 1), modifies the destination IP address of the session control packet to be the IP address of the target access device while keeping the source IP address of the session control packet unchanged, and sends the modified session control packet to the target access device.

The procedure of determining the target access device of the session control packet may include: identifying an access device to which the user is connected as the target access device corresponding to the session control packet by using information of the user in the session control packet and user information provided by the access devices 1-3.

The proxy device 102 may store the IP addresses of all access devices 1-3 in advance so as to replace the destination IP address of the session control packet with the IP address of the target access device after the target access device is identified and send the session control packet to the target access device.

At block 204, the access device 1, which is the target access device in this example, receives the session control packet from the proxy device 102, performs a session control procedure according to the session control packet, and returns a session control response to the session management device 101 by using the source IP address of the session control packet, the source IP address of the session control response is set to be the IP address of the proxy device.

The source IP address of the session control packet sent by the proxy device 102 is the IP address of the session management device 101, thus the access device 1 may obtain the IP address of the session management device 101 from the session control packet. In addition, since the session control packet is sent by the session management device 101 to the proxy device 102, the session control response should be sent from the proxy device 102 to the session management device 101. Therefore, the access device 1 may store the IP address of the proxy device 102 in advance, and act as the proxy device to return the session control response after receiving the session control packet sent by the proxy device, i.e., the source IP address of the session control response is set to be the IP address of the proxy device 102, and the destination IP address of the session control response is set to be the IP address of the session management device 101. The session control response is the above mentioned response packet.

In the example as shown in FIG. 2, access functions are configured in the access devices 1-3, e.g., the access devices 1-3 provides access authentication, therefore the duty of performing session control procedures required by the session management device 101 are shifted from a single NAS to multiple access devices, thus workload of the NAS can be reduced. In addition, the proxy device 102 deployed between the access devices 1-3 and the session management device 101 forwards session control packets sent by the session management device 101 to the access devices 1-3, and thus enables the session management device 101 to implement session control of users simply by sending session control packets to the proxy device 102 as long as the session management device 101 has the information of the proxy device 102. As such, configuration of the session management device 101 is simple and does not change with changes in the device that performs the actual session control procedures.

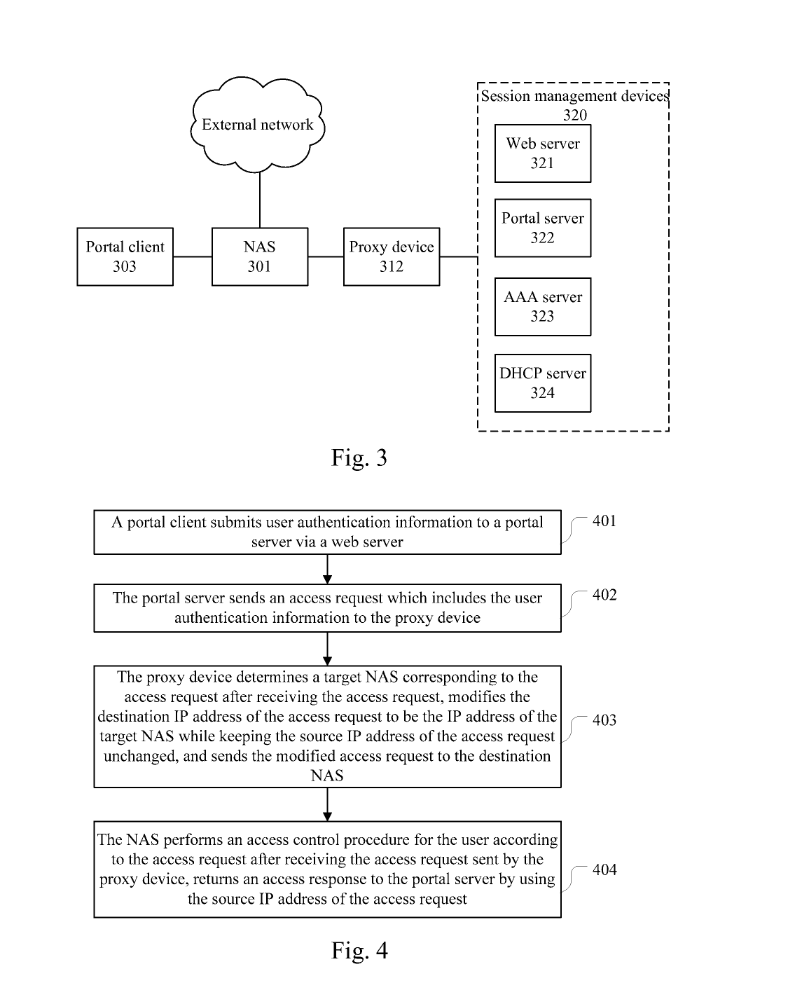

FIG. 3 is a schematic diagram illustrating a portal network in accordance with an example of the present disclosure. A single NAS 301 is shown but there may be multiple NASs in the network. The NASs serve as access devices, and have session control functions. For example, the NAS 301 serves as an access device for a portal client 303 or other user devices. Examples of session management devices 320 are shown and may include web server 321, portal server 322, AAA server 323 and DHCP server 324. The portal server 322 may communicate with the access devices (e.g., NASs including the NAS 301) to provide session information. A proxy device 312 is deployed between the NASs and the portal server 322.

FIG. 4 is a flowchart illustrating a network session control method applied to the network as shown in FIG. 3 in accordance with an example of the present disclosure. The method describes an example where a session management device is to allow the access of a user who has requested to access the network and sends an access request as the request packet to the proxy device 312. For other types of session control, e.g., perform session control for a connected user, terminating a session of a user, or terminating a session of a user who has requested to quit logon, the session control method may be similar to that as shown in FIG. 4. The method may include the following procedures.

At block 401, the portal client 303 submits user authentication information to the portal server 322 via the web server 321.

In an example, the portal client 303 may visit a logon interface provided by the web server 321 via the NAS 301, and submit the user authentication information, e.g., a user name, a password and the like. The web server 321 may submit the user authentication information to the portal server 322. The NAS 301 may record access information of the user when the portal client 303 visits the logon interface provided by the web server 321 via the NAS 301, and sends the user access information to the proxy device 312 for synchronization. The user access information may include information of the user (e.g., a user ID), information of the NAS 301 (e.g., a device ID or the like). Through this procedure, the proxy device 312 obtains access information of all users having visited the logon interface of the web server 321 through the NAS 301.

At block 402, the portal server 322 sends an access request which includes the user authentication information to the proxy device 312.

In an example, the portal server 322 may store the IP address of the proxy device 312 in advance, and implements access authentication of the user by sending an access request to the proxy device 312.

The access request is the type of request packet used in the process of communicating session information between the portal server 322 and the NAS 301.

In an example, after receiving the user authentication information submitted by the portal client 303 via the web server 321, the portal server 322 may send the access request to the proxy device 312, instead of to the NAS 301.

The access request may include information of the user who is the target of the session control, e.g., a user name, a password or the like.

At block 403, after receiving the access request, the proxy device 312 determines a target NAS corresponding to the access request, modifies the destination IP address of the access request to be the IP address of the target NAS while keeping the source IP address of the access request unchanged, and sends the modified access request to the target NAS.

In an example, the procedure of determining the target NAS corresponding to the access request may include: identifying an access device (e.g., a NAS of multiple NASs in the network) via which the user visited the logon interface provided by the web server 321 as the target NAS corresponding to the request packet by using information of the user in the access request and user access information obtained previously from the NASs.

The proxy device 312 may store the IP addresses of all NASs in advance so as to replace the destination IP address of the access request with the IP address of the target NAS after the target NAS is identified and send the access request to the target NAS.

At block 404, after receiving the access request sent by the proxy device 312, the target NAS performs an access control procedure according to the access request, and acts as the proxy device 312 to return an access response to the portal server 322 by using the source IP address of the access request.

Before performing the access control procedure for the user according to the access request, the target NAS may send information of the user to an authentication server, e.g., the AAA server 323, determine whether the user has passed the authentication according to feedback information returned by the AAA server 323 indicating whether the user has passed authentication, establishing a session for the user if the user has passed authentication, or reject establishing a session for the user if the user failed to pass the authentication.

The response packet may include a result of the session control procedure performed. For example, when the user requests to access the network, information indicating access succeeded or failed may be included in the response packet according to an authentication result of the user.

Since the source IP address of the access request sent by the proxy device 312 is the IP address of the portal server 322, the target NAS may obtain the IP address of the portal server 322 from the access request. In addition, since the access request is sent from the portal server 322 to the proxy device 312, the access response should be sent from the proxy device 312 to the portal server 322. Therefore, the target NAS may store the IP address of the proxy device 312 in advance, and acts as the proxy device to return the access response after receiving the access request, i.e., setting the source IP address of the access response to be the IP address of the proxy device, and the destination IP address of the access response to be the IP address of the portal server 322.

The access response is a type of response packet used in the process of communicating session information between the portal server 322 and the target NAS.

In the example as shown in FIG. 4, the proxy device 312 deployed between the NAS 301 and the portal server 322 forwards access requests sent by the portal server 322 to the access devices (e.g., the NAS 301) so that the portal server 322 for example may only store information of the proxy device 312 and send access requests to the proxy device 312 to implement access authentication of users. The configuration of the portal server 322 is simple, and does not change with changes in NASs.

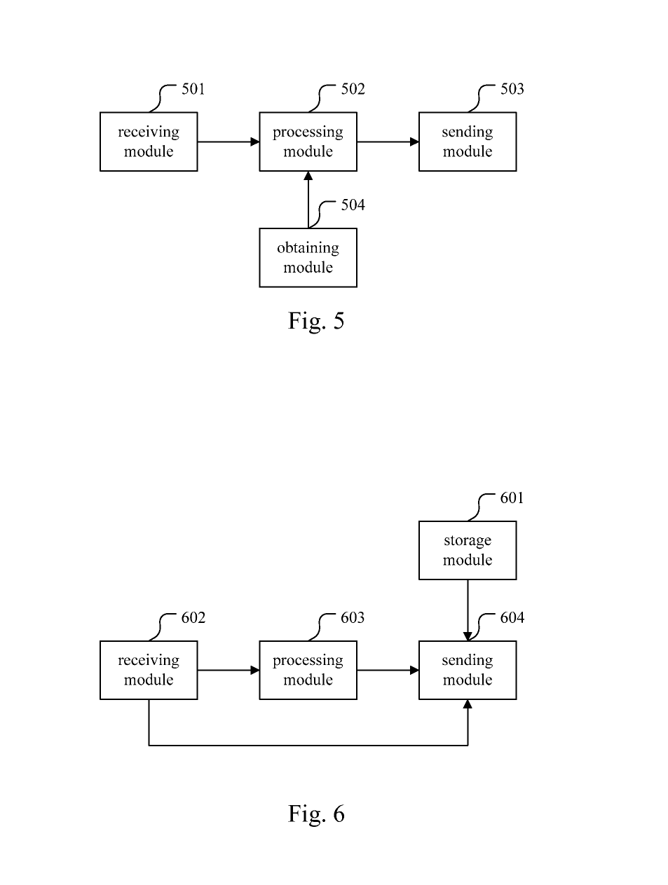

The above are examples illustrating an asymmetrical IP proxy mechanism. Various examples also provide a proxy device and an access device which are described in the following with reference to FIG. 5 and FIG. 6.

FIG. 5 is a schematic diagram illustrating modules of a proxy device, such as proxy device 102 shown in FIG. 1 or proxy device 312 shown in FIG. 3, in accordance with an example of the present disclosure. The proxy device is deployed in a network having access devices capable of performing access authentications of users. The network may also include a session management device capable of communicating session information with the access devices. The proxy device is deployed between the access devices and the session management device, and may include the following components.

A receiving module 501 receives a request packet sent by the session management device.

A processing module 502 determines a target access device corresponding to the request packet, and modifies the destination IP address of the request packet to be the IP address of the target access device while keeping the source IP address of the request packet unchanged.

A sending module 503 sends the modified request packet to the target access device to make the target access device act as the proxy device to return a response packet to the session management device by using the IP address of the proxy device stored in advance in the target access device and the source IP address of the request packet, i.e., the source IP address of the response packet is set to be the IP address of the proxy device, and the destination IP address of the response packet is set to be the source IP address of the request packet, i.e., the IP address of the session management device.

In an example, the proxy device may also include an obtaining module 504.

When the network is an access network, the session management server is an AAA server, and the request packet is a session control packet for an authenticated user sent by the session management device.

The obtaining module 504 obtains from each of the access devices access information of users authenticated at the access device. The user access information may include information of a user and information of an access device the user is connected to.

The processing module 502 may determine the target access device corresponding to the request packet by identifying an access device the user is connected to as the target access device corresponding to the request packet by using information of the user in the request packet and access information of users authenticated by each of the access devices obtained in advance from all of the access devices.

In an example, when the network is a portal network, the access device may be a NAS, the session management device may be a portal server, and the request packet may be an access request sent by the portal server after the portal server received user authentication information submitted by a not-yet-logged-in user through a logon interface provided by a web server.

The obtaining module 504 may obtain from the access devices access information of users having visited the logon interface provided by the web server via each of the access devices. The access information of a user may include information of the user and information of the access device via which the user visited the logon interface provided by the web server.

The processing module 502 may determine the target access device corresponding to the request packet by identifying an access device via which the user visited the logon interface provided by the web server as the target access device corresponding to the request packet by using information of the user in the request packet and user access information obtained previously from the access devices.

FIG. 6 is a schematic diagram illustrating modules of an access device, such as any of access devices 1-3 shown in FIG. 1 or NAS 301 shown in FIG. 3, in accordance with an example of the present disclosure. The access device is configured with user access authentication functions. The network where the access device resides also includes a session management device capable of communicating session information with the access device. A proxy device is deployed between the access device and the session management device. The access device may include a storage module 601, a receiving module 602, a processing module 603 and a sending module 604.

The storage module 601 stores the IP address of the proxy device in advance.

The receiving module 602 receives from the proxy device a request packet initiated by the session management device. The proxy device modified the destination IP address of the request packet to be the IP address of the access device while keeping the source IP address of the request packet unchanged when forwarding the request packet.

The processing module 603 performs a session control procedure according to the request packet received by the receiving module 602.

The sending module 604 acts as the proxy device to return a response packet to the session management device by using the IP address of the proxy device stored in advance and the source IP address of the request packet, i.e., the sending module 604 sets the source IP address of the response packet to be the IP address of the proxy device and sets the destination IP address of the response packet to be the source IP address of the request packet, i.e., the IP address of the session management device.

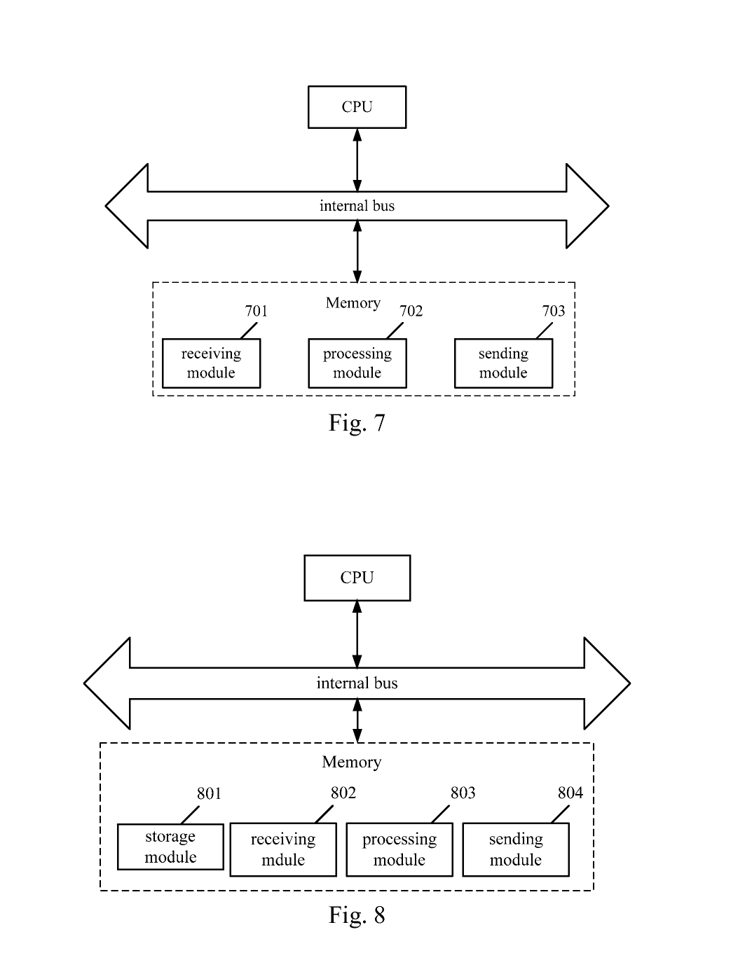

FIG. 7 is a schematic diagram illustrating modules of a proxy device, such as proxy device 102 shown in FIG. 1 or proxy device 312 shown in FIG. 3, in accordance with an example of the present disclosure. The proxy device may include a processor and a memory. The memory may include a receiving module 701, a processing module 702, and a sending module 703. Functions of the receiving module 701, the processing module 702 and the sending module 703 are similar to those of the receiving module 501, the processing module 502 and the sending module 503 as shown in FIG. 5. Functions of the receiving module 701, the processing module 702 and the sending module 703 may be implemented with assistance of other modules, e.g., performing calculations by using the processor, storing in the memory various information and data, e.g., information of a user, information of an access device, information of a packet, temporary data, intermediate data, and so on. The proxy device may also include an internal bus capable of transporting information between the modules. The internal bus may be a bus connected with each of the modules, or be a collection of multiple wired or wireless links between the modules.

FIG. 8 is a schematic diagram illustrating modules of an access device, such as any of access devices 1-3 shown in FIG. 1 or NAS 301 shown in FIG. 3, in accordance with an example of the present disclosure. The access device may include a processor and a memory. The memory may include a storage module 801, a receiving module 802, a processing module 803, and a sending module 804.

The storage module 801 stores the IP address of the proxy device in advance.

The receiving module 802 receives from the proxy device a request packet initiated by a session management device. The source IP address of the request packet is the IP address of the session management device. The request packet includes information of a session control procedure to be performed for a user.

The processing module 803 performs a session control procedure for the user according to the request packet.

The sending module 804 generates a response packet and sends the response packet to the session management device. The source IP address of the response packet is set to be the IP address of the proxy device stored in the access device in advance, and the destination IP address of the response packet is set to be the source IP address of the request packet.

Functions of the storage module 801, the receiving module 802, the processing module 803 and the sending module 804 may be implemented with assistance of other modules, e.g., performing calculations by using the processor, storing in the memory various information and data, e.g., information of a user, information of the proxy device, information of a packet, temporary data, intermediate data, and so on. The access device may also include an internal bus capable of transporting information between the modules. The internal bus may be a bus connected with each of the modules, or be a collection of multiple wired or wireless links between the modules.

The access device may be a network device having exchanging capabilities, e.g., switches. The access device may also have session control functions, i.e., capable of performing access authentication of users, terminating a session of a user and the like.

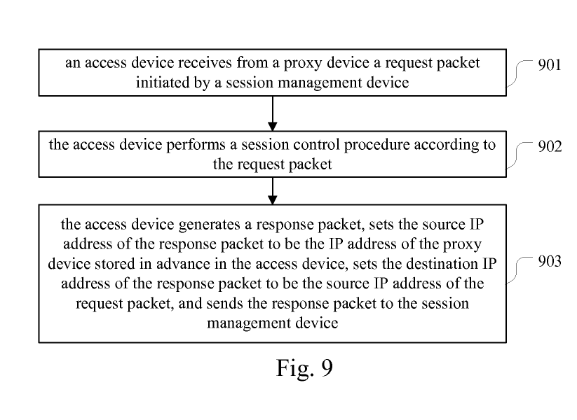

FIG. 9 is a network session control method in accordance with an example of the present disclosure. The method is applicable to a network having access devices and a session management device. The network also has a proxy device which is deployed between the access devices and the session management device. The method may include the following procedures.

At block 901, an access device receives from a proxy device a request packet initiated by a session management device. The source IP address of the request packet is the IP address of the session management device. The request packet may include information of a session control procedure to be performed for a user, e.g., access authentication of a user, terminating a session of a user, and the like.

At block 902, the access device performs the session control procedure for the user according to the request packet.

For example, when the user requested access, the access device may establish a session for the user. In an example, the access device may send information of the user to an authentication server, e.g., an AAA server, and determine whether the user has passed the authentication according to feedback information returned by the AAA server indicating whether the user has passed authentication, establish a session for the user if the user has passed authentication, or reject establishing a session for the user if the user failed to pass the authentication.

At block 903, the access server generates a response packet and sends the response packet to the session management device. The source IP address of the response packet is set to be the IP address of the proxy device stored in the access device in advance, and the destination IP address of the response packet is set to be the source IP address of the request packet. The response packet may include a result of the session control procedure performed. For example, when the user requests for access, information indicating access succeeded or failed may be included in the response packet according to an authentication result of the user.

It should be understood that in the above processes and structures, not all of the procedures and modules are necessary. Certain procedures or modules may be omitted according to the needs. The order of the procedures is not fixed, and can be adjusted according to the needs. The modules are defined based on function simply for facilitating description. A module may be implemented by multiple modules, and functions of multiple modules may be implemented by the same module. The modules may reside in the same device or distribute in different devices. The “first”, “second” in the above descriptions are merely for distinguishing two similar objects, and have no substantial meanings.

The modules described above may be implemented in hardware and/or as machine readable instructions. For example, a module may be a hardware module including dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

In other examples the modules described above may be implemented by machine readable instructions executed by a processor. In that case a machine-readable storage medium may be provided, which is to store machine-readable instructions to cause a machine to execute a method as described herein. A module may thus include the machine readable instructions stored on the machine-readable medium (e.g., memory) and executed by the processor. Specifically, a system or apparatus having a storage medium which stores machine-readable program codes for implementing functions of any of the above examples and which may make the system or the apparatus (or CPU or MPU) read and execute the program codes stored in the storage medium. In addition, instructions of the program codes may cause an operating system running in a computer to implement part or all of the operations. In addition, the program codes implemented from a storage medium are written in a storage device in an extension board inserted in the computer or in storage in an extension unit connected to the computer. In this example, a CPU in the extension board or the extension unit executes at least part of the operations according to the instructions based on the program codes to realize the technical scheme of any of the above examples.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. In one example, the program code may be downloaded from a server computer via a communication network.

The scope of the claims should not be limited by the embodiments set forth in the examples, but should be given the broadest interpretation consistent with the description as a whole.

1. A network session control method wherein a network includes access devices capable of performing access authentication of users and a session management device capable of communicating session information to the access devices and, the method comprising:
receiving, by a proxy device, a request packet from the session management device, the request packet including information of a user;
determining a target access device of the access devices corresponding to the request packet by using the information of the user in the request packet;
modifying a destination IP address of the request packet to be an IP address of the target access device while keeping a source IP address of the request packet unchanged; and
sending the modified request packet to the target access device.

2. The method of claim 1, further comprising:
the target access device returning a response packet to the session management device by using an IP address of the proxy device stored in advance and the source IP address of the request packet.

3. The method of claim 2, wherein returning the response packet to the session management device comprises:
setting a source IP address of the response packet to be the IP address of the proxy device; and
setting a destination IP address of the response packet to be the source IP address of the request packet.

4. The method of claim 1, further comprising:
sending, by the target access device, information of the user to the proxy device after performing access authentication for the user; and
storing, by the proxy device, a relation which associates the information of the user with the access device,
wherein the determining of the target access device comprises identifying the access device associated with the information of the user in the stored relation as the target access device corresponding to the request packet.

5. The method of claim 1, wherein
when the network is an access network, the session management device is an authentication, authorization and accounting (AAA) server, and the request packet is a session control packet for an authenticated user sent by the session management device, and the method comprises:
obtaining from each of the access devices, by the proxy device, access information of users authenticated at the access device; access information of a user including information of the user and information of an access device the user is connected to, and wherein
the determining of the target access device corresponding to the request packet comprises: identifying an access device the user is connected to as the target access device corresponding to the request packet by using information of the user in the request packet and access information of users authenticated at each of the access devices obtained in advance from all of the access devices.

6. The method of claim 1, wherein
when the network is a portal network, each of the access devices is a network access server (NAS), the session management device is a portal server, and the request packet is an access request sent by the portal server after the portal server received user authentication information submitted by a not-yet-logged-in user through a logon interface provided by a web server, and the method comprises:
obtaining from the access devices, by the proxy device, access information of users having visited the logon interface provided by the web server via each of the access devices; and accessing information of a user including information of the user and information of the access device via which the user visited the logon interface provided by the web server,
wherein the determining of the target access device corresponding to the request packet comprises: identifying an access device via which the user visited the logon interface provided by the web server as the target access device corresponding to the request packet by using information of the user in the request packet and accessing information of users obtained previously from all of the access devices.

7. A proxy device to facilitate network session control in a network, the network including access devices capable of performing access authentication of users and a session management device capable of communicating session information with the access devices, wherein the proxy device is deployed between the access devices and the session management device, and comprises: a receiving module, a processing module and a sending module; and wherein:—
the receiving module is to receive a request packet sent by the session management device;
the processing module is to determine a target access device corresponding to the request packet, and modify a destination IP address of the request packet to be an IP address of the target access device while keeping a source IP address of the request packet unchanged; and
the sending module is to send the modified request packet to the target access device to cause the target access device to return a response packet to the session management device by using an IP address of the proxy device stored in advance and a source IP address of the request packet.

8. The proxy device of claim 7, wherein the receiving module is further to store a relation which associates information of the user with an access device of the access devices after receiving information of the user sent by the access device which has performed access authentication for the user; and
the processing module is to identify the access device associated with the information of the user in the stored relation as the target access device corresponding to the request packet.

9. The proxy device of claim 7, further comprising an obtaining module,
wherein when the network is an access network, the session management device is an authentication, authorization and accounting (AAA) server, and the request packet is a session control packet for an authenticated user sent by the session management device,
the obtaining module is to obtain from each of the access devices access information of users authenticated at the access devices, and access information of a user including information of the user and information of an access device the user is connected to; and
the processing module is to determine the target access device corresponding to the request packet by identifying an access device of the access devices the user is connected to as the target access device corresponding to the request packet by using information of the user in the request packet and access information of users authenticated by each of the access devices obtained in advance from all of the access devices.

10. The proxy device of claim 7, further comprising an obtaining module,
wherein when the network is a portal network, the access device is a network access server (NAS), the session management device is a portal server, and the request packet is an access request sent by the portal server after the portal server received user authentication information submitted by a not-yet-logged-in user through a logon interface provided by a web server,
the obtaining module is to obtain from the access devices access information of users having visited the logon interface provided by the web server via each of the access devices, and the access information of a user including information of the user and information of the access device via which the user visited the logon interface provided by the web server; and
the processing module is to determine the target access device corresponding to the request packet by identifying an access device of the access devices via which the user visited the logon interface provided by the web server as the target access device corresponding to the request packet by using information of the user in the request packet and user access information obtained previously from the access devices.

11. An access device to facilitate network session control in a network, the network including access devices, a proxy device and a session management device, the access device comprising:
a storage module, a receiving module, a processing module and a sending module;
wherein the storage module is to store an IP address of the proxy device in advance;
the receiving module is to receive from the proxy device a request packet initiated by the session management device, wherein a source IP address of the request packet is an IP address of the session management device, and the request packet includes information of a session control procedure to be performed for a user;
the processing module is to perform the session control procedure for the user according to the request packet; and
the sending module is to generate a response packet and send the response packet to the session management device, wherein a source IP address of the response packet is set to be an IP address of the proxy device stored in the access device in advance, and a destination IP address of the response packet is set to be the source IP address of the request packet.
